(19) United States
(12) Patent Application Publication
(10) Pub. No.: US 2004/0138965 A1
(43) Pub. Date: Jul. 15, 2004

(54) System and method for communicating sales messages

(75) Inventors: Chuck Laughlin, Crystal Bay, NV (US); Karen Sage, Crystal Bay, NV (US); Dwight DePalmer, Incline Village, NV (US)

Correspondence Address: Michael A. Kerr, Virtual Legal, 777 E. William St., #211, Carson City, NV, 89701, US

(73) Assignee: Corporate Visions, Inc., Incline Village, NV

(21) Appl. No.: 10/716,384

(22) Filed: Nov. 17, 2003

Related U.S. Application Data
(60) Provisional application No. 60/427,399, filed on Nov. 18, 2002.
(60) Provisional application No. 60/452,614, filed on Mar. 4, 2003.

(51) Int. Cl. G06F 17/60

(52) U.S. Cl. 705/27

(57) ABSTRACT

A system and method for delivering a sales presentation. The method includes providing a structure for the sales presentation. The method then generates a plurality of sales messages that are organized according to the structure. A performance is then generated for each of the sales messages. Each of the performances are then stored in signal bearing media. A plurality of company representatives are permitted to access the signal bearing media. At least one of the representatives then communicates the sales presentation to a prospect. The system comprises a display, a signal bearing media, an input device, and a central processing unit. The display is configured to display a plurality of performances. The signal bearing media is configured to store the performances. The input device is configured to permit a company representative to interact with the plurality of performances. The central processing unit is communication with the signal bearing media and is configured to permit the company representative to access the performances stored on the signal bearing media.

### CROSS REFERENCES TO RELATED APPLICATIONS

This patent application is related to provisional patent application 60/427,399 which was filed on Nov. 18, 2002 and is titled “System and Method for Developing A Sales Strategy”, and provisional patent application 60/452,614 which was filed on Mar. 4, 2003 and is titled “A System and Method For Communicating Sales Messages”.

### BACKGROUND OF THE INVENTION

1. Field of Invention

The invention is related to developing and communicating a sales strategy that differentiates a company from a competitor.

2. Description of Related Art

The rift between a corporation's marketing department and the corporations sales department results in the failure of sales people to effectively communicate and to address the concerns of a prospect. A prospect is a potential buyer for either a product(s) or service(s), or the combination of product(s) and service(s).

Typically, the marketing department of the corporation focuses on developing the “message” associated with the company's product(s) and/or service(s). This message is communicated on a relatively broad and general level to a target audience that includes the prospect. By way of example and not of limitation, the message is communicated using advertising that is seen on television and/or in publications such as trade journal(s). Additionally the marketing department is responsible for developing a branding strategy that is used to distinguish the company's product(s) and/or service(s) from one or more competitor's product(s) and/or service(s).

The sales department of the corporation is more focused on making an actual sale to the prospects. Thus, the sales person is focused on communicating directly with the prospect. Generally, the message communicated by the sales person is confusing and fails to address the particular concerns of the prospect. Nevertheless, there are exceptional sales people whose performance exceeds expectations. These exceptional sales people distinguish themselves by being able to effectively communicate a successful sales strategy to prospects. Regretfully, most sales people are unable to communicate the successful sales strategy to prospects.

### SUMMARY

A system and method for delivering a sales presentation. The method includes providing a structure for the sales presentation. The method then generates a plurality of sales messages that are organized according to the structure. A performance is then generated for each of the sales messages. By way of example and not of limitation, an illustrative performance for each sales message is performed by a presenter such as an “all-star” sales person. Each of the performances are then stored in signal bearing media. A plurality of company representatives are permitted to access the signal bearing media. At least one of the representatives then communicates the sales presentation to a prospect. In one embodiment, the method receives feedback regarding at least one of the sales messages.

The system comprises a display, a signal bearing media, an input device, and a central processing unit. The display is configured to display a plurality of performances. The signal bearing media is configured to store the performances. By way of example and not of limitation, an illustrative performance for each sales message is performed by a presenter such as an “all-star” sales person. The input device is configured to permit a company representative to interact with the plurality of performances. The central processing unit is communication with the signal bearing media and is configured to permit the company representative to access the performances stored on the signal bearing media.

### BRIEF DESCRIPTION OF THE DRAWINGS

Embodiments for the following description are shown in the following drawings:

FIG. 1 is an illustrative general purpose computer.

FIG. 2 is an illustrative client-server system.

FIG. 3 is a flowchart of an illustrative method for communicating a sales presentation.

FIG. 4 is a diagram of an illustrative structure used to generate the sales presentation.

FIG. 5 is a simplified drawing showing the process of recording an “all-star” sales person's performance.

FIG. 6 is an illustrative interactive interface that is shown on a display.

FIG. 7 is a method for storing presentations and/or performances after the performance of the sales message has been generated.

FIG. 8 is an interactive method for storing presentations and/or performances in a searchable database.

FIG. 9 is a schematic with an organizational overview for delivering a sales presentation.

FIG. 10 is a screenshot showing an interactive interface that permits a user to view a plurality of message objects.

FIG. 11 is a screenshot showing an interactive interface for a prospect profile.

FIG. 12 is a screenshot showing an interactive interface in which the illustrative message object for the illustrative first power position is a competitive matrix.

FIG. 13 is a screenshot showing an interactive interface in which the illustrative message object for the illustrative first power position is a three-dimensional prop.

FIG. 14 is a screenshot showing an illustrative coach for the performance associated with the illustrative message object in FIG. 13.

FIG. 15 is a screenshot showing an interactive interface in which the illustrative message object is linked to a plurality of documents.

FIG. 16 is a screenshot showing an interactive interface in which a search can be performed for a particular message object.

### DESCRIPTION

In the following detailed description, reference is made to the accompanying drawings, which form a part of this application. The drawings show, by way of illustration, specific embodiments in which the invention may be practiced. It is to be understood that other embodiments may be utilized and structural changes may be made without departing from the scope of the appended claims.

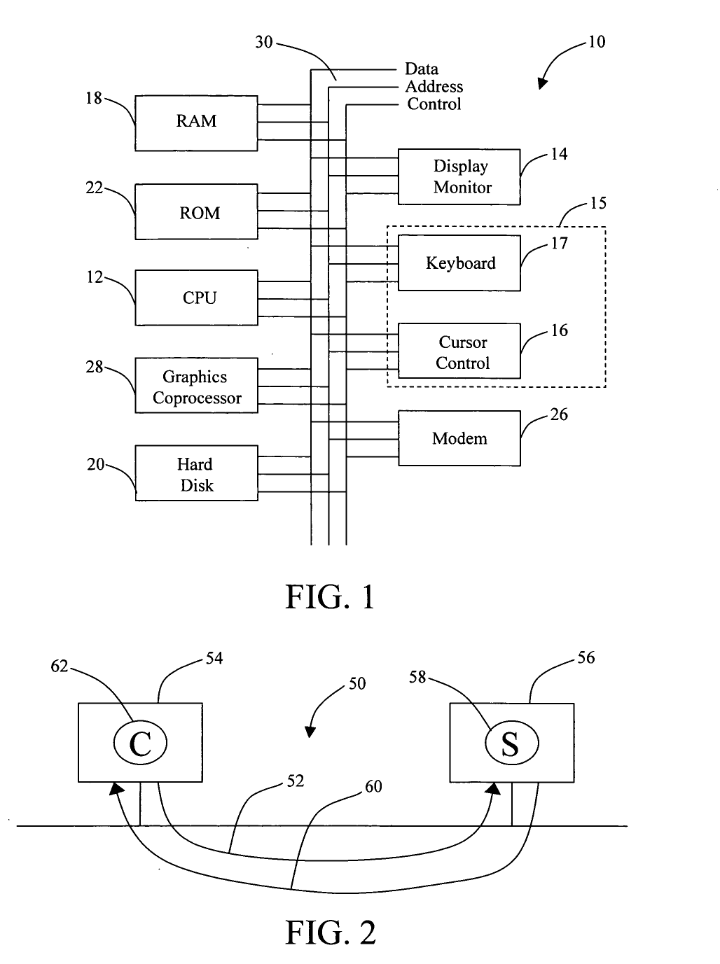

Referring to FIG. 1 there is shown an illustrative general purpose computer 10 suitable for implementing the systems and methods described herein. The general purpose computer 10 includes at least one central processing unit (CPU) 12, a display such as monitor 14, and an input device 15 such as cursor control device 16 or keyboard 17. The cursor control device 16 can be implemented as a mouse, a joy stick, a series of buttons, or any other input device which allows user to control the position of a cursor or pointer on the display monitor 14. Another illustrative input device is the keyboard 17. The general purpose computer may also include random access memory 18, external storage 20, ROM memory 22, a keyboard 24, a modem 26 and a graphic co-processor 28. All of the elements of the general purpose computer 10 may be tied together by a common bus 30 for transporting data between the various elements.

The bus 30 typically includes data, address, and control signals. Although the general purpose computer 10 illustrated in FIG. 1 includes a single data bus 30 which ties together all of the elements of the general purpose computer 10, there is no requirement that there be a single communication bus which connects the various elements of the general purpose computer 10. For example, the CPU 12, RAM 18, ROM 22, and graphics co-processor might be tied together with a data bus while the hard disk 20, modem 26, keyboard 24, display monitor 14, and cursor control device are connected together with a second data bus (not shown). In this case, the first data bus 30 and the second data bus could be linked by a bi-directional bus interface (not shown). Alternatively, some of the elements, such as the CPU 12 and the graphics co-processor 28 could be connected to both the first data bus 30 and the second data bus and communication between the first and second data bus would occur through the CPU 12 and the graphics co-processor 28. The methods of the present invention are thus executable on any general purpose computing architecture, but there is no limitation that this architecture is the only one which can execute the methods of the present invention.

Alternatively, the methods of the invention can be implemented in a client/server architecture which is shown in FIG. 2. It shall be appreciated by those of ordinary skill in the art that a client/server architecture 50 can be configured to perform similar functions as those performed by the general purpose computer 10. In the client-server architecture communication generally takes the form of a request message 52 from a client 54 to the server 56 asking for the server 56 to perform a server process 58. The server 56 performs the server process 58 and sends back a reply 60 to a client process 62 resident within client 54. Additional benefits from use of a client/server architecture include the ability to store and share gathered information and to collectively analyze gathered information. In another alternative embodiment, a peer-to-peer network (not shown) can used to implement the methods of the invention.

In operation, the general purpose computer 10, client/server network system 50, and peer-to-peer network system execute a sequence of machine-readable instructions. These machine readable instructions may reside in various types of signal bearing media. In this respect, one aspect of the present invention concerns a programmed product, comprising signal-bearing media tangibly embodying a program of machine-readable instructions executable by a digital data processor such as the CPU 12 for the general purpose computer 10.

It shall be appreciated by those of ordinary skill that the signal-bearing media may comprise, for example, RAM 18 contained within the general purpose computer 10 or within a server 56. Alternatively the instructions may be contained in another signal-bearing media, such as a magnetic data storage diskette that is directly accessible by the general purpose computer 10 or the server 56. Whether contained in the general purpose computer or in the server, the machine readable instruction may be stored in a variety of machine readable data storage media, such as a conventional “hard drive” or a RAID array, magnetic tape, electronic read-only memory (ROM), an optical storage device such as CD-ROM, DVD, or other suitable signal bearing media including transmission media such as digital and analog and communication links. In an illustrative embodiment, the machine-readable instructions may comprise software object code, compiled from a programming language such as C++ or Java.

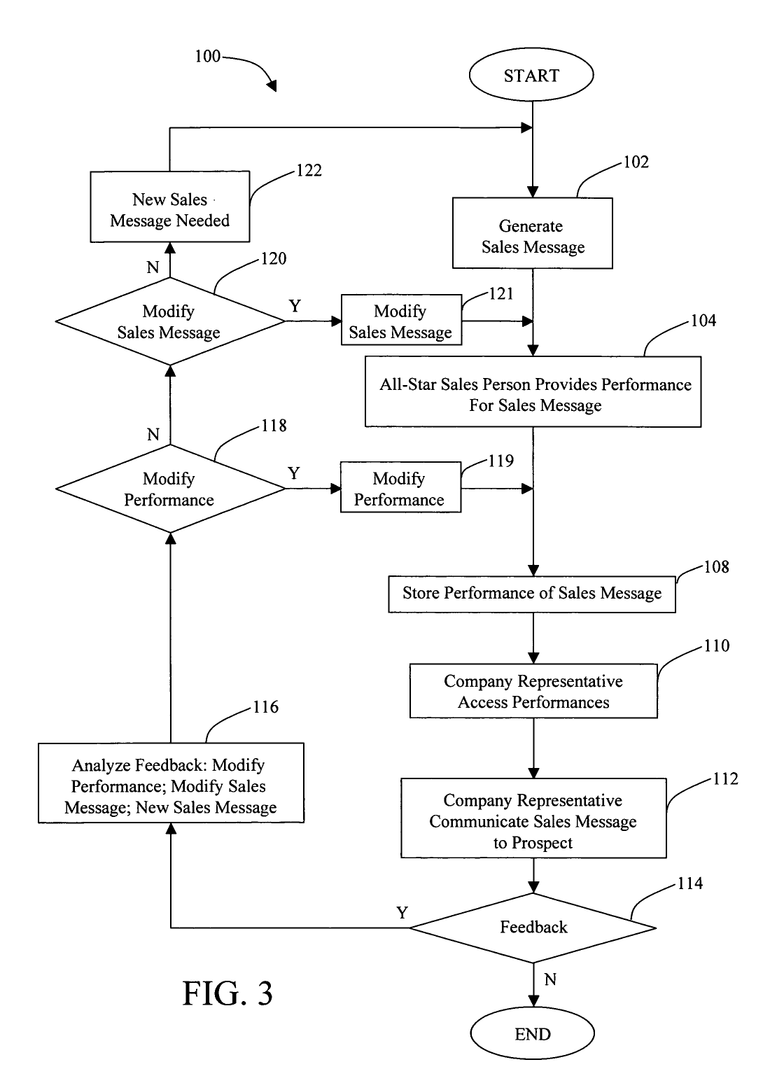

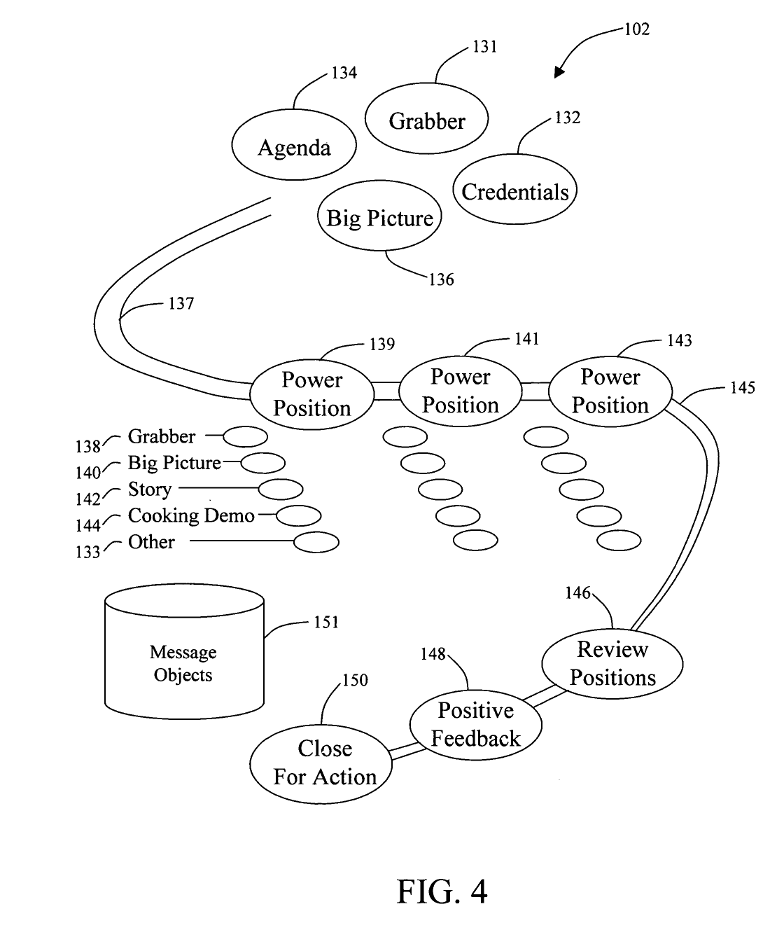

FIG. 3 is a flowchart of the method for delivering a sales presentation. The sales presentation is delivered on behalf of a company. For purposes of this specification, the company includes such legal entities as a sole proprietor, a partnership, a limited liability company, a corporation, and any other such legal entity. The method is initiated at process block 102 in which a plurality of sales messages are generated. The sales messages are organized in a structured manner. The structure of the sales presentation may vary. An illustrative structure for generating a sales presentation is provided in FIG. 4. The illustrative structure for the sales presentation is described in further detail below. After the desired sales messages have been generated the method proceeds to process block 104.

At process block 104, an “all-star” sales person provides a performance for each sales message. The sales message is recorded using equipment intended to capture audio and video for each performance. By way of example and not of limitation, a video recorder is used to capture the audio and video for each performance. Typically, the “all-star” sales person is a successful sales person. Alternatively, the all-star sales person can be an individual that is charged with instructing company representatives.

Thus, the sales message that is communicated to company representatives is a sales message that is influenced by the most successful sales people. For purposes of this specification, a company representative includes company sales people, resellers, consultants and any other person authorized to represent the company delivering the sales presentation. For example, other company employees besides company sales people can also be company representatives.

Generally, each performance is complemented with comments about the sales message. A comment refers to the general use of words, phrases and sentences to highlight important aspects of each sales message. For purposes of this specification, the term “performance” generally includes comments that complement the performance. The method then proceeds to process block 108.

At process block 108, the performances for each sales message are stored in a signal bearing media. The type of signal bearing media depends on the particular application. By way of example and not of limitation, the performances may be stored on a CD or DVD. In another illustrative example, the performances may be stored on a server that can be accessed using the Internet, an intranet, or an extranet.

Generally, the sales messages are organized so that company representatives accessing the signal bearing media can. easily find one or more particular performances, comments, and/or sales message. There are various searching methods that can be used to find a particular performance and/or sales message. One such searching method includes providing an interactive user interface that is organized using a combination of buttons and pull-down menus, or an interactive user interface that permits a user to perform word searches, or by using a combination of these searching methods.

Additionally, sales messages and their associated performances can be combined to generate presentations of various lengths. By way of example and not of limitation, two minute, seven minute and twenty minute presentations can be generated. These “canned” presentations can be used to provide a company representative with an illustrative example of how to provide an effective presentation to a prospect.

At process block 110, company representatives' are permitted to access the stored performances. As previously described, a company representative includes resellers and consultants. By way of example and of limitation consultants and resellers may have limited access to specific sales messages or performances. Limited access may be provided to preserve trade secrets and other sensitive intellectual properties.

An illustrative company representative accesses performances associated with one or more sales messages to prepare for meetings with one or more prospects. These performances can be viewed at the illustrative company representative's leisure. Depending on the type of access available to the company representative, the company representative can also provide feedback about the performances or the sales messages.

By way of example and not of limitation, one way of accessing the performances is to use the Internet's World Wide Web, or simply “Web”. Utilizing browsers such as Internet Explorer or Netscape, the company representative can access the performances from any location having an Internet connection. Another method for accessing the performances uses an intranet or an extranet. Yet a third method for accessing the performances is to use a CD or DVD.

The Internet is a networking infrastructure that connects millions of computers together and forms a network in which any computer can communicate with any other computer as long as they are both connected to the Internet. Information travels over the Internet using protocols such as TCP/IP for data transfer. An intranet provides similar services to the Internet, however the intranet network is not necessarily connected to the Internet. The intranet is generally used within a company for internal communications. An extranet is an extension of an intranet that uses the Internet. By way of example and not of limitation, an extranet permits suppliers and mobile employees to access the company's data and applications using the World Wide Web.

The method then proceeds to process 112 in which the company representative communicates one or more sales message to a prospect. The sales messages may be delivered as presentations of various lengths that can target the prospect's needs. For example, the sales messages may be combined into 2 minute, 7 minute and 20 minute presentations. Alternatively, the sales messages can be organized to address particular problems or needs that have been communicated by prospects in positions or industries. By applying knowledge gained from the sales message and the recorded performances, the company representative has an opportunity to communicate a clear sales message about the company to the prospect.

After communicating the sales message to the prospect, the method then proceeds to decision diamond 114 in which feedback is received. The feedback may be from the company representative or may be directly from a prospect. The feedback can be related to the sales message being communicated, the performance of the sales message, or the need for a new sales message. Each of these situations is described in further detail below. If there is no feedback to communicate, then the method is completed. However, if there is feedback then the feedback is analyzed as described in process block 116.

The feedback is analyzed to determine the type of feedback provided. Generally, there are three different types of feedback that can be provided. The first type of feedback is related to the performance of one or more sales message. The second type of feedback is related to the sales message. The third type of feedback is directed to the generation of a new sales message.

If the determination is made at decision diamond 118 that the feedback is related to one or more particular performances, the performance is modified at process block 119. The modified performance is stored in process block 108. The performance can be modified by adding comments, modifying comments, and/or modifying the performance presented by an illustrative all-star sales person. Typically, the modification of the performance is determined by evaluating feedback and determining that the feedback provides the appropriate basis to modify the performance.

If the determination is made at decision diamond 120 that the sales message is to be modified, then the sales message is modified at process block 121. The method then proceeds to process block 104 where the corresponding performance and comments are also changed to reflect the modification to the sales message.

At times there may changes that require generating new sales messages. For example, there may be a new competitor, or new products and/or services offered by a competitor that the company representative must be prepared to address. Additionally, the prospect may communicate the need for a particular product or service, and the current sales message may not address the prospect's needs. To effectively address this type of feedback, a new sales message may be needed. This need is determined in process block 122. The method would then proceed to process block 102 where the new sales message is generated which would directly address the challenge posed by the competitor and/or would address the prospect's needs.

Referring to FIG. 4 there is shown a diagram of an illustrative structure used to generate the sale presentation. The illustrative structure for the sales presentation is embodied in a “Message Map” that communicates a plurality of sales messages. Thus, the presentation communicates a plurality of sales messages using the illustrative structure that is described in further detail below.

For purposes of this description, the term sales message refers to a sales message and/or a marketing message unless there is an obvious distinction between the sales message and the marketing message. The “Message Map” structure permits a plurality of sales messages to be organized into an effective sales presentation. The Message Map structure is a visual metaphor that is used to develop an effective sales presentation. With respect to the Message Map structure, each of the sales messages are described as either message objects and power positions. Therefore, the Message Map is a combination of message objects and power positions that communicate a plurality of sales messages. Each message object has a form, structure and intent that communicates a specific sales message. Generally, each of the message objects is associated with one or more power positions. A power position is a more general sales message that communicates a company's uniqueness and a company's value that facilitates the prospect's ability to make a decision. A power position is typically comprised of a plurality of message objects. Thus, a general sales message, e.g. power position, is supported by a plurality of specific sales messages, i.e. message objects.

The Message Map is composed of three sections: the first section is a launch; the second section is a body; and the third section is a closing. Each of these sections is tied together by a unifying theme referred to as a “meta message”. The launch includes a first set of message objects that are presented at the beginning of a sales presentation. The message objects related to the launch include a grabber 131, a set of credentials 132, an agenda 134, and a “big picture” 136.

The grabber 131 is an opening that “grabs” the prospects attention. The grabber is embodied as a word play, a “story”, a three-dimensional prop, or a mini drama. Word play refers to the combined use of words and/or numbers to grab the prospect's attention. The “story” is a story that shows how the prospect's needs can be satisfied using the company's products and/or services. A three-dimensional prop is a demonstrative tool that identifies a problem and/or a solution. A mini drama describes the prospect's current pain and stress and the advantages of the company's solution.

The credentials 132 show that the company's representative has the credibility and experience to provide the prospect with a desirable solution. The agenda 134 identifies the prospect's problems and how the company's solution will address the prospect's problems and concerns. The “big picture” 136 is a graphic that is used to describe the competitive solution provided by the company.

The next section of the Message Map is referred to as the “body”. The body is connected to the launch with a meta message 137 that communicates the unifying theme of the sales presentation. The body includes a plurality of power positions. A power position is a general sales message that includes a plurality of message objects that communicates a company's uniqueness and value. This value facilitates the prospects ability to make a decision. Guidelines for identifying power positions include identifying unique and/or advantageous qualities of the company that are important to the prospect.

By way of example and not of limitation, a power position is comprised of message objects that include a grabber 138, a big picture 140, a story 142, and a cooking demo 144 and other message objects 133. The grabber 138, big picture 140, and story 142 are message objects that are focused on communicating a particular sales message. The cooking demo 144 gives a working experience which, by way of example, include describing the company's solution and demonstrating the company's technology.

The third section is related to the closing and includes message objects related to the three-step close. Again a meta message 145 provides a unifying theme to connect the body of power positions to the closing. The message objects for the three-step close include reviewing the power positions 146, getting feedback 148, and closing for action 150. The reviewing of the power positions 146 is completed to remind the prospect of what was previously discussed. The feedback process 148 provides an opportunity for the prospect to vocalize the benefits of the company's products and/or services. This feedback process 148 is also referred to as positive feedback. However, if the feedback provided by the prospect is negative, the company representative has an opportunity to overcome the negative feedback by identifying the company's positive qualities. The close for action 150 is a close directed to generating future activity between the prospect and the company.

Additionally, the Message Map structure may also include a database of message objects 151. The database 151 can be used to search for appropriate message objects that fit into the desired location within the Message Map structure. The database 151 can thereby ensure that the message objects are used to generate an effective sales presentation.

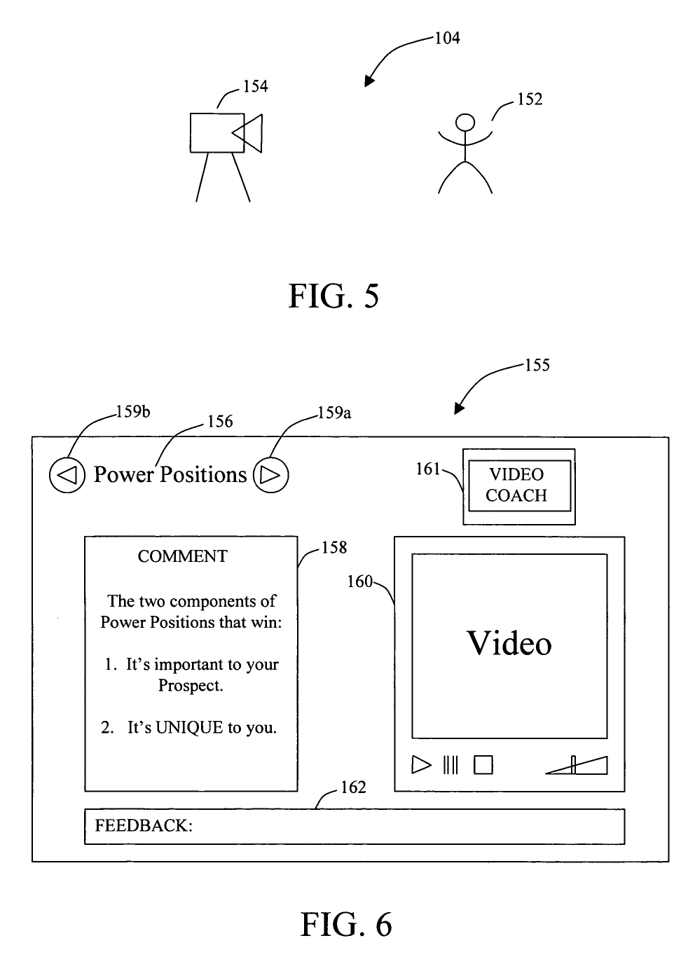

Referring to FIG. 5 there is shown a simplified illustrative drawing for the process of recording an “all-star” sales person's performance. By way of example and not of limitation, during the recording of an illustrative performance, an “all-star” sales person 152 is selected to provide a particular performance for one or more message objects. For illustrative purposes only, the all-star sales person is a company employee that has a history of successfully implementing effective sales strategies. It shall be appreciated by those skilled in the art, that the “all-star” sales person does not have to be a company employee and can be an independent contractor, representative, or actor that has been retained to provided the performance for one or more sales messages.

In the illustrative embodiment, the all-star sales person's 152 performance is captured using a conventional digital video recorder 154. The digital video recorder 154 can be mounted on a tripod. The quality of the audio and video recording will depend on the recording equipment, and the method used for distributing the performances. In certain instances various well known compression and decompression techniques will be used to process and distribute video performances.

Referring to FIG. 6 there is shown is an illustrative user interface that is displayed to a company representative. For this particular illustrative user interface 155 the sales message that is communicated is related to defining a power position. The comment 158 about the particular message object 156 indicates that a “Power Position” is important to the prospect and is unique to the company. The video 160 provided on the illustrative user interface 155 is a performance that describes the general message communicated by the power position. As previously described, the performance can be provided by an all-star sales person. By way of example and not of limitation, the recording of the performances is disseminated using various well known distribution methods that include video servers, a browser, and streaming media technologies such as provided by Microsoft MediaPlayer™. By way of example and not of limitation, Flash technology and Macromedia can be used to generate the interactive user interface.

Additionally, the interface 155 is an interactive user interface that can receive various inputs from the company representative. These inputs can be related to selecting the appropriate sales message by scrolling through the presentation using the buttons 159a and 159b. Additional inputs that can engaged by the user includes the video coach 161, i.e. a virtual agent, that describes in further detail the structure that is used for the sales presentation. Yet another input associated with the user interface 155 may include a feedback section 162. The feedback section 162 is configured to receive feedback from the company employee about the particular sales message, the performance of the sales message, the comments, the relative success or failure associated with the particular message object, and the need for new sales messages.

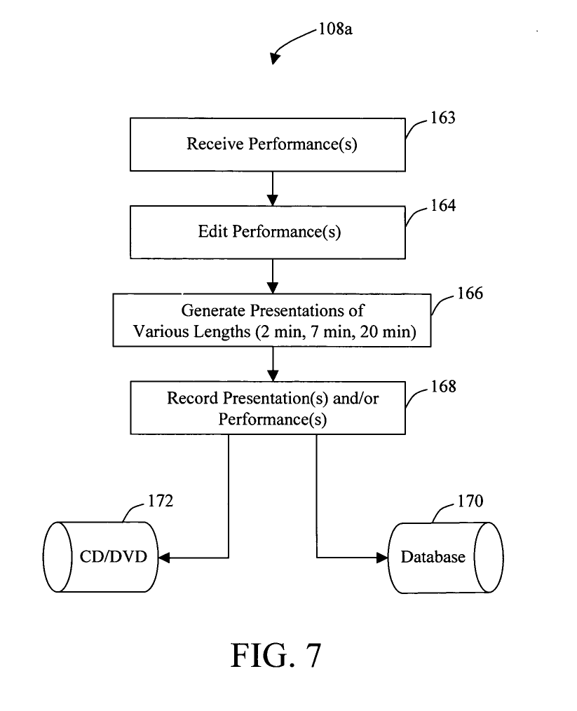

Referring to FIG. 7 there is shown a method for storing performances in a signal bearing media. As previously mentioned, the signal bearing media is configured to store machine readable instructions that are executed by the general purpose computer 10, client/server network system 50, or a peer-to-peer network system. Additionally, the performances can be combined in a structured manner to generate a sales presentation. The presentation is a plurality of sales messages that are organized in a structured manner. In one embodiment, the presentation is delivered to the prospect by a company representative. In another embodiment, the presentation is delivered to the prospect by using the Web using a virtual company representative.

A presentation is generated by first receiving performances as indicated by process block 163. Each performance is then edited so that the appropriate message is communicated within a desired time period as indicated by process block 164. At process block 166, the presentation is generated by combining performances. The presentation is then recorded in process block 168. By way of example and not of limitation, the recorded presentations have a length of two minutes, seven minutes and twenty minutes. The presentations are recorded on a signal bearing media such as a searchable database 170, or a CD/DVD 172.

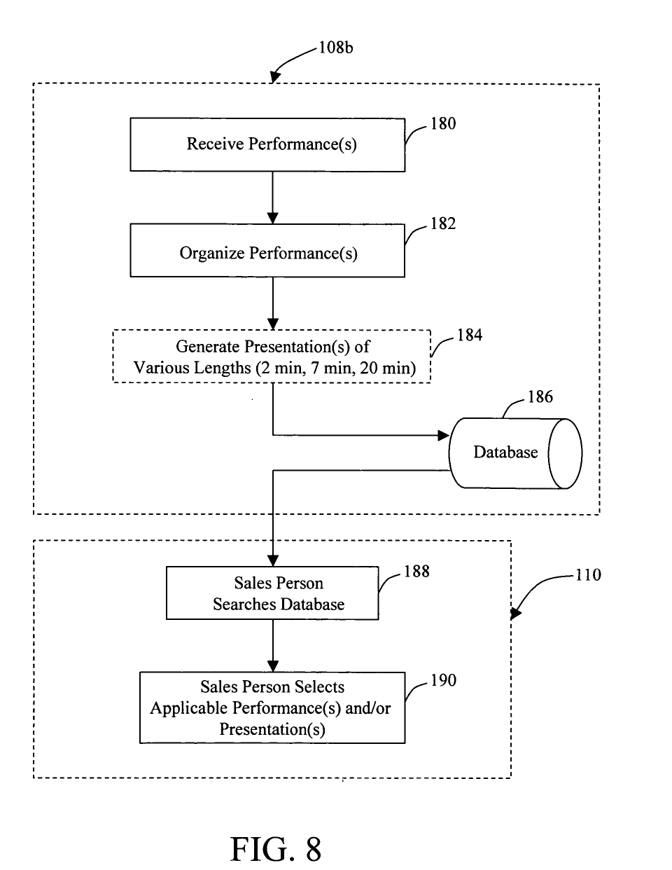

Referring to FIG. 8 there is shown a method storing performances in a searchable database. The performances stored in the searchable database are received by an illustrative server as shown in process block 180. The performances are then organized to permit an illustrative sales person to find a particular performance, comment and/or sales message as shown in process block 182. There are various searching methods that can be used to find a particular performance and/or sales message. One such searching method includes providing an interactive user interface that is organized using a combination of buttons, and pull down menus, or an interactive user interface that permits a user to perform word searches, or by using a combination of these searching methods. These performances, comments and sales messages can then be directly stored in the searchable database 186.

In an alternative embodiment, the process of storing performances in a searchable database includes combining a plurality of performances into presentations as shown in process block 184. The presentations can also be stored in the searchable database 186.

By way of example and not of limitation, the searchable database 186 is an XML repository that supports the content. The content may include performances, presentations, comments or sales messages. The benefit of the XML repository is that it can be run independently without a server and can support search browsing, category browsing, and off-line computer usage without having to rely on the dependency of a server.

In process block 188, the searchable database 186 is then accessed by the illustrative sales person. The method then proceeds to process block 190 in which the illustrative sales person can then select the desired performance or presentation for a particular prospect.

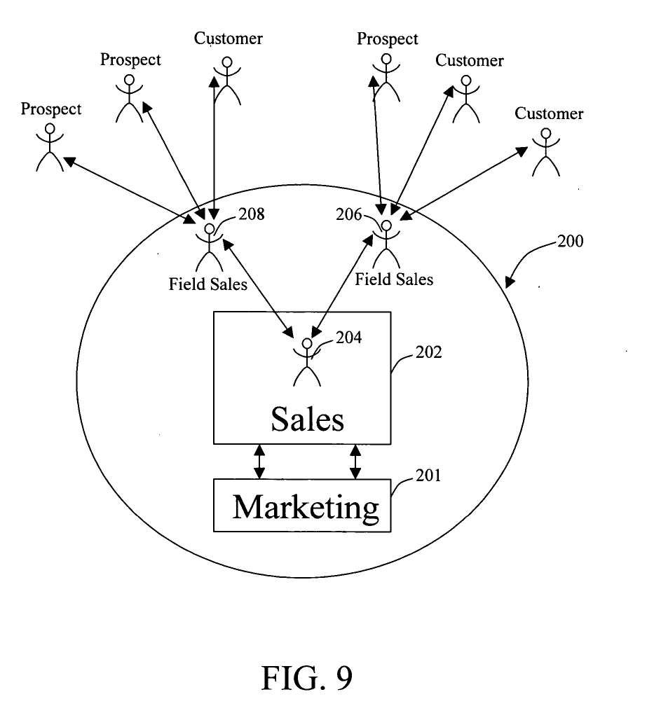

Referring to FIG. 9 there is shown a schematic with an organizational overview for delivering the sales presentation. The schematic 200 shows a marketing block 202 that represents a marketing department. Generally, the marketing departments is charged with developing the materials and advertising to describe the company's products and/or services. The marketing department works in tandem with the sales department which is identified by block 204. The sales department is more focused on making a direct sales to one or more prospects.

Using the systems and methods described above, the sales department can effectively communicate a sales presentation to company representatives in the field. The sales messages are effective and consistent because the sales messages are generated in a centralized location. Thus, by using performances generated from an all-star sales person 204, the company representatives 206 and 208 can more effectively communicate with prospects and customers.

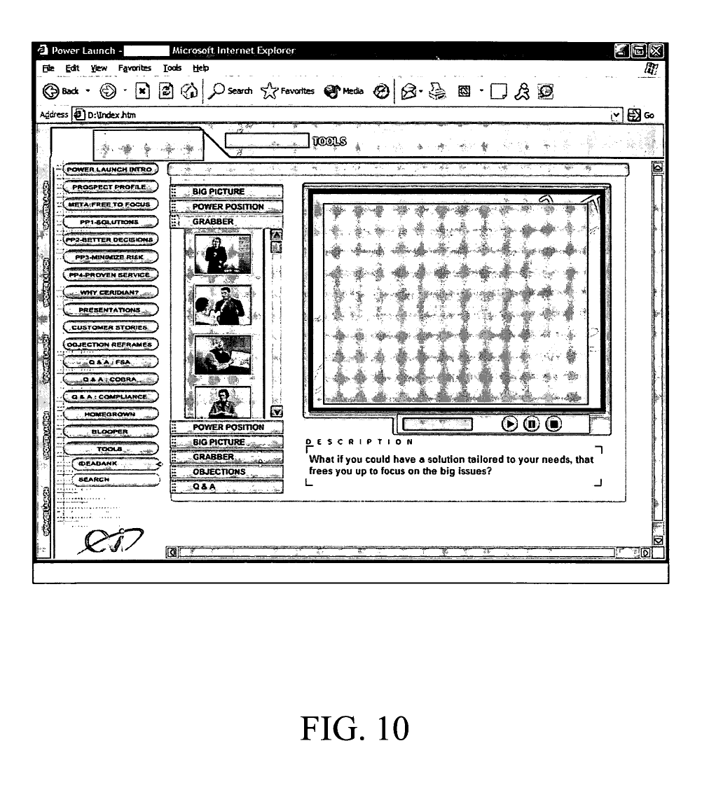

Referring to FIG. 10 there is shown an illustrative screenshot showing an interactive interface that permits a user to select one of a plurality of message objects. The performances are organized as a database of sales messages which is referred to as an “Ideabank”. The Ideabank provides the company representation with a plurality of message objects that can be used for a particular presentation.

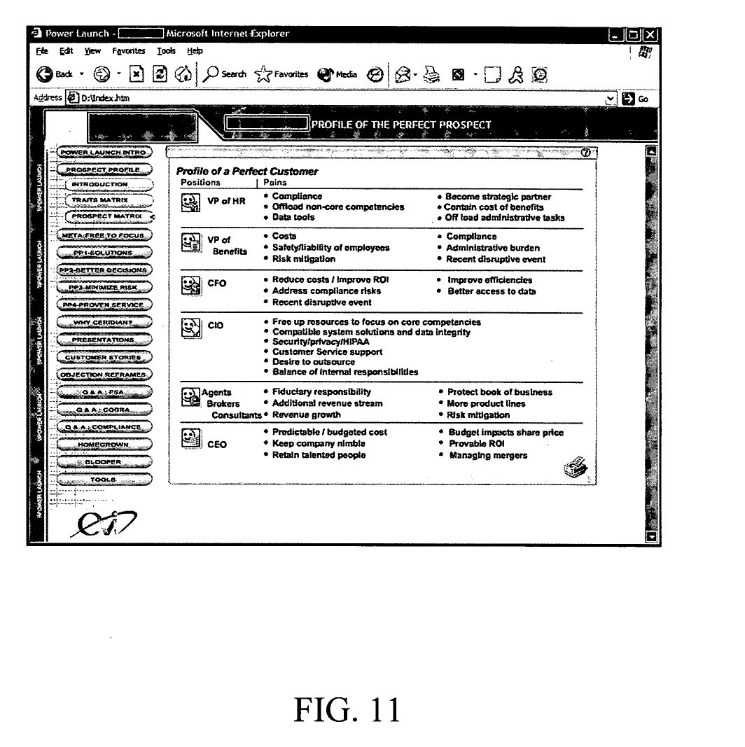

Referring to FIG. 11 there is shown an illustrative screenshot showing an interactive interface with a prospect profile. The prospect profile is a profile of the prospect that assists the company representative in structuring a targeted sales presentation. The profile describes the various pains associated with a particular within the prospect's organization.

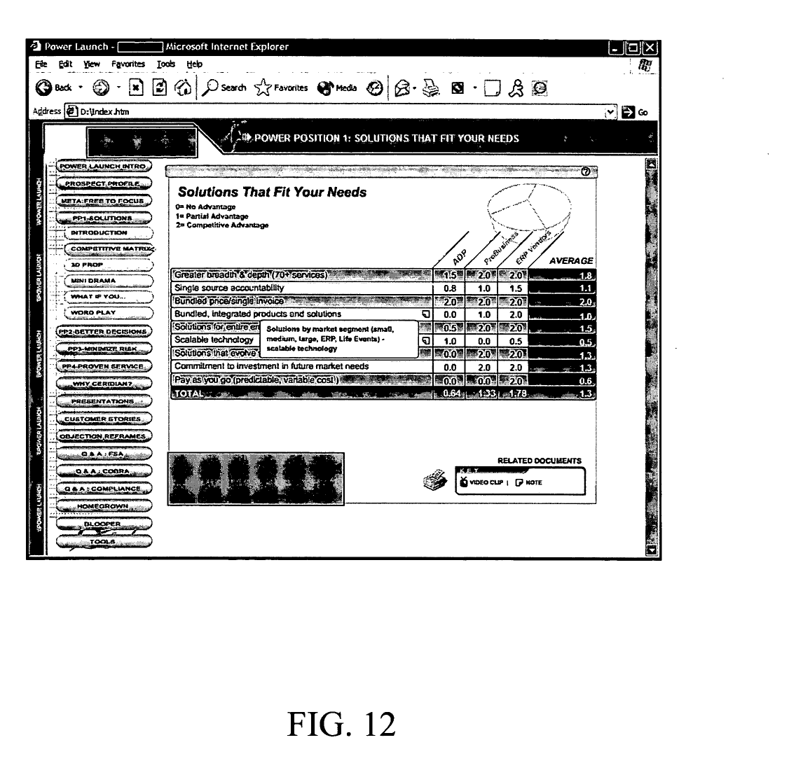

Referring to FIG. 12 there is shown an illustrative screenshot in which the illustrative message object for the illustrative first power position is a competitive matrix. The message object is referred to as the competitive matrix. The competitive matrix is a sales message that supports the company solution. Additionally the competitive matrix shows that competitors do not meet the prospect's needs.

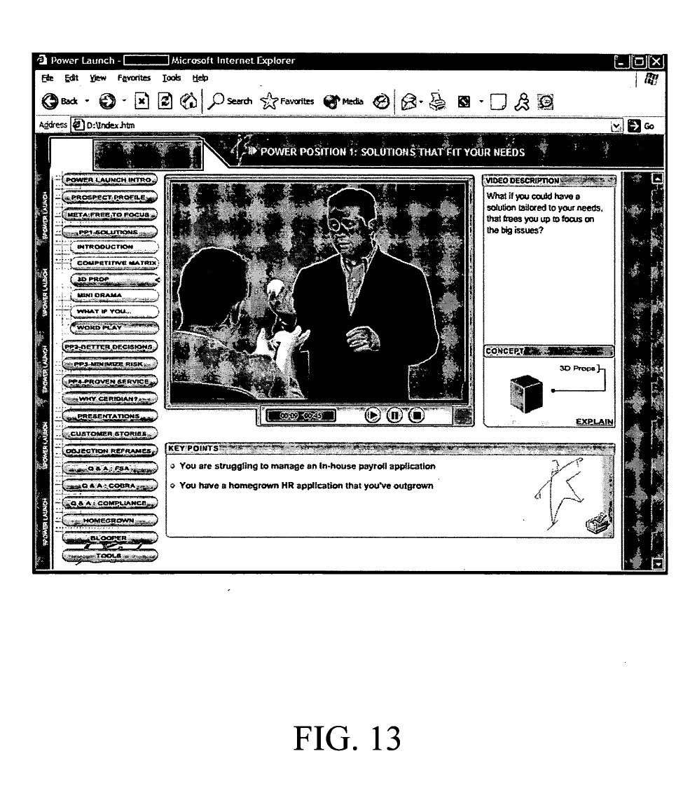

Referring to FIG. 13 there is shown an illustrative screenshot in which the illustrative message object for the illustrative first power position is a three-dimensional prop. The three-dimensional prop is used to provide a physical metaphor that describes either the prospect's pain and/or a solution to the prospect's pain.

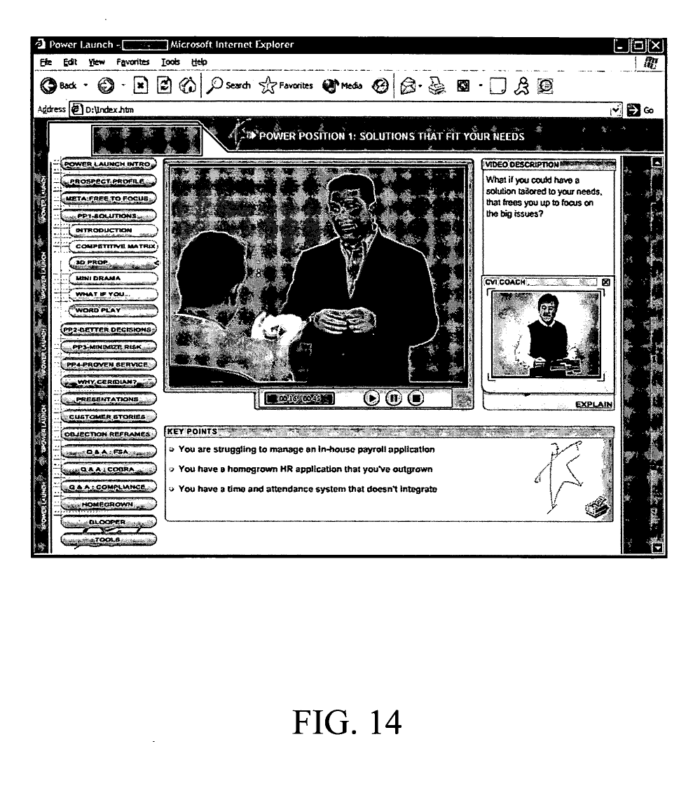

Referring to FIG. 14 there is shown an illustrative screenshot showing an illustrative coach, i.e. virtual agent, that describes the illustrative message object in FIG. 13. The coach describes the performance and the general conceptual framework for the particular message object. Thus, the company representative can more easily grasp the sales message and the structure within which to apply the particular sales message.

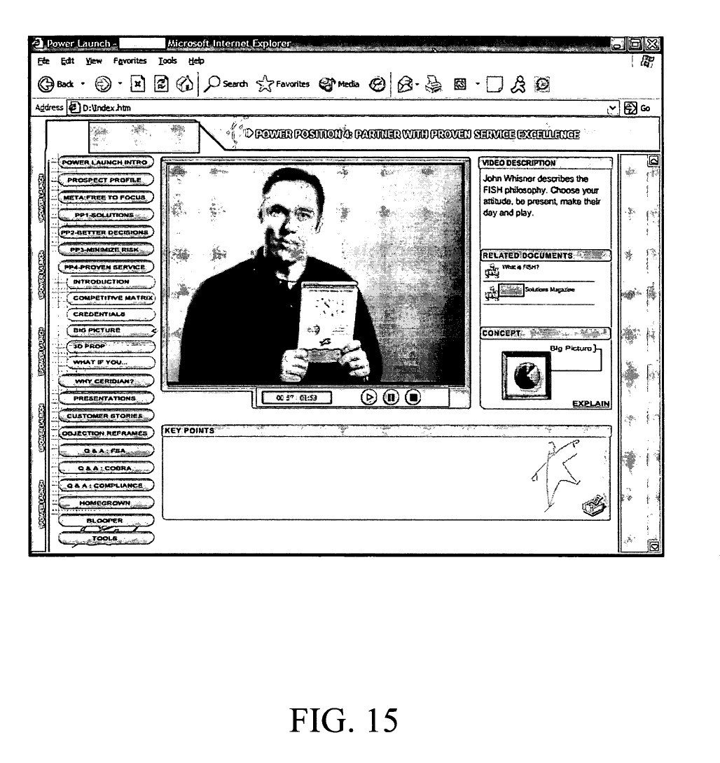

Referring to FIG. 15 there is shown an illustrative screenshot showing in which the illustrative message object is linked to a plurality of documents. By way of example, the plurality of documents may be located in a corporate intranet so that the documents can be quickly and easily revised.

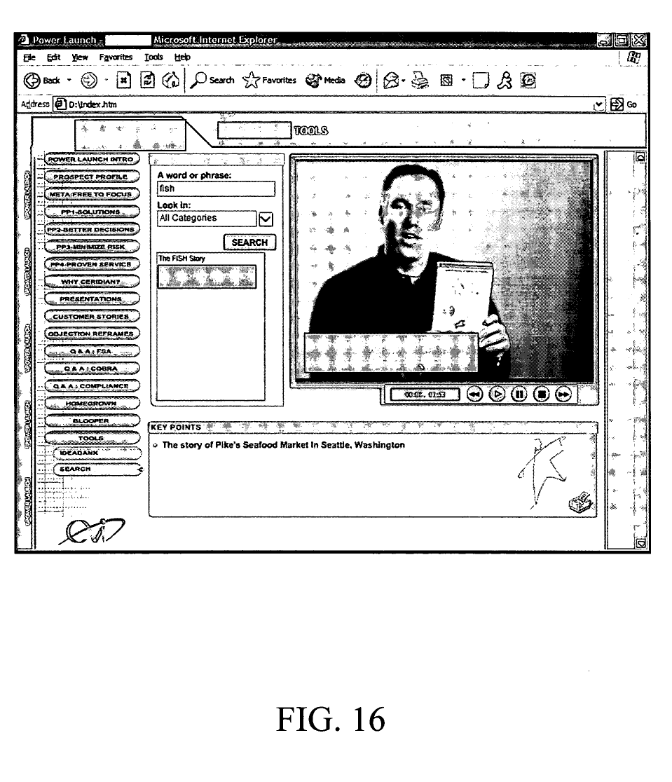

Referring to FIG. 16 there is shown a screenshot in which a search can be performed for a particular message object. The search permits the company representative to readily access sales message or presentations. By way of example, the sales messages can be embodied in message objects and power positions.

Although the description about contains many limitations in the specification, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A method for delivering a sales presentation, comprising:
providing a structure for said sales presentation;
generating a plurality of sales messages that are organized according to said structure;
generating a performance for each of said plurality of sales messages;
storing each of said performances in a signal bearing media;
permitting a plurality of company representatives to access said signal bearing media; and
having at least one of said plurality of representatives communicate said sales presentation to a prospect.

2. The method of claim 1 wherein each of said plurality of sales messages are embodied in at least one message object.

3. The method of claim 1 wherein before generating said performance for each of said plurality of sales messages, the method further comprises generating at least one power position, said power position configured to communicate at least one sales message that is unique to a company.

4. The method of claim 3 wherein said power position is comprised of a plurality of message objects.

5. The method of claim 1 wherein said structure is explained to said plurality of company representatives having access to said signal bearing media.

6. The method of claim 1 wherein said performance includes an audio performance.

7. The method of claim 1 wherein said performance includes a comment.

8. The method of claim 1 wherein said performance includes an audio component and a video component.

9. The method of claim 1 wherein said structure includes providing an agenda.

10. The method of claim 1 wherein said structure includes providing a big picture.

11. The method of claim 1 wherein said structure includes providing a plurality of credentials.

12. The method of claim 1 wherein said structure includes providing a grabber.

13. The method of claim 1 wherein said structure includes providing a review of one or more sales messages that were previously presented.

14. The method of claim 1 wherein said structure includes providing a request for positive feedback from said prospect.

15. The method of claim 1 wherein said structure includes providing a response to negative feedback from said prospect.

16. The method of claim 1 further comprising receiving feedback about at least one of said plurality of sales messages.

17. The method of claim 16 wherein after receiving feedback, the method further comprises modifying one of said performances.

18. The method of claim 16 wherein after receiving feedback, the method further comprises modifying one of said plurality of sales messages.

19. The method of claim 16 wherein after receiving feedback, the method further comprises generating a new message object.

20. The method of claim 1 further comprising permitting a portion of said plurality of company representatives to having limited access to said signal bearing media.

21. The method of claim 1 further comprising generating at least one illustrative sales presentation that conforms to said structure.

22. The method of claim 21 wherein each of said illustrative sales presentation have a particular length of time.

23. The method of claim 1 wherein said performance is performed by an “all-star” sales person.

24. A method for delivering a sales presentation, comprising:
providing a structure for said sales presentation;
generating a plurality of sales messages that are organized according to said structure;
generating a performance for each of said plurality of sales messages;
storing each of said performances in a searchable database;
permitting a plurality of company representatives to access said searchable database; and
having at least one of said plurality of representatives communicate said sales presentation to a prospect.

25. The method of claim 24 wherein said plurality of company representatives are permitted to access said searchable database using the Internet.

26. The method of claim 24 wherein said plurality of company representatives are permitted to access said searchable database using an intranet.

27. The method of claim 24 wherein said plurality of company representatives using an extranet to access said searchable database are provided with limited access.

28. The method of claim 24 wherein each of said plurality of sales messages are embodied in at least one message object.

29. The method of claim 24 wherein before generating said performance for each of said plurality of sales messages, the method further comprises generating at least one power position, said power position configured to communicate at least one sales message that is unique to a company.

30. The method of claim 29 wherein said power position is comprised of a plurality of message objects.

31. The method of claim 24 wherein said structure is explained to said plurality of company representatives having access to said signal bearing media.

32. The method of claim 24 wherein said performance includes an audio performance.

33. The method of claim 24 wherein said performance includes a comment.

34. The method of claim 24 wherein said performance includes an audio performance and a video performance.

35. The method of claim 24 further comprising receiving feedback about at least one of said plurality of sales messages.

36. The method of claim 35 wherein after receiving feedback, the method further comprises modifying one of said performances.

37. The method of claim 35 wherein after receiving feedback, the method further comprises modifying one of said plurality of sales messages.

38. The method of claim 35 wherein after receiving feedback, the method further comprises generating a new message object.

39. The method of claim 24 further comprising permitting a portion of said plurality of company representatives to having limited access to said signal bearing media.

40. The method of claim 24 further comprising generating at least one illustrative sales presentation that conforms to said structure.

41. The method of claim 40 wherein each of said illustrative sales presentation have a particular length of time.

42. The method of claim 24 wherein said performance is performed by an “all-star” sales person.

43. A system for delivering a sales presentation having a structure wherein said structure is used for organizing a plurality of sales messages that are communicated in said sales presentation, comprising:
a display configured to display a plurality of performances, wherein each of said plurality of performances is related to one of said plurality of sales messages;
a signal bearing media configured to store said plurality of performances;
an input device configured to permit a company representative to interact with said plurality of performances stored in said signal bearing media;
a central processing unit in communication with said signal bearing media, said central processing unit configured to permit said company representative to access said plurality of performances stored on said signal bearing media.

44. The system of claim 43 wherein said signal bearing media is a server.

45. The system of claim 43 wherein said signal bearing media comprises a searchable database.

46. The system of claim 43 wherein at least one said plurality of performances is generated using a video recorder that records video and audio of said performance.

47. The system of claim 43 wherein said input device is configured to receive feedback from said company representative regarding at least one of said plurality of performances.

48. The system of claim 43 wherein said display is configured to provide a virtual agent that explains said structure.

49. The system of claim 43 wherein said central processing unit resides on a server and said display resides on a client.

50. The system of claim 49 wherein said signal bearing media resides on said server.
